(19) United States
(12) Patent Application Publication
(10) Pub. No.: US 2026/0213424 A1
(43) Pub. Date: Jul. 23, 2026

(54) OPTICALLY TRANSPARENT REFLECTIVE METASURFACE WITH INCREASED OPACITY UTILIZING MESHED UNIT CELLS

(71) Applicant: Dell Products L.P., Round Rock, TX (US)

(72) Inventors: Tejinder Singh, San Jose, CA (US); Navjot Kaur Khaira, San Jose, CA (US); Morris Repeta, Ottawa (CA); David F. Hardy, Ottawa (CA); Keigan Macdonell, Ottawa (CA); Shulabh Gupta, Ottawa (CA)

(21) Appl. No.: 19/274,301

(22) Filed: Jul. 18, 2025

Related U.S. Application Data
(60) Provisional application No. 63/747,219, filed on Jan. 20, 2025.

(51) Int. Cl. H01Q 15/00; G02B 1/00; H01P 1/203; H01Q 15/16

(52) U.S. Cl. CPC H01Q 15/0086; G02B 1/002; H01P 1/20309; H01Q 15/168

(57) ABSTRACT

The technology described herein is generally directed towards an optically-transparent metasurface (or reflectarray) for millimeter-wave applications based on a honeycomb metal-meshing scheme and fine metal line structures. The reflectarray unit cells (elements) can be arranged in a hexagonal lattice structure to achieve a high packing density. In one implementation, the reflectarray unit cells include metallic hexagonal resonating elements in the form of hexagonally-shaped rings, backed with a metal ground plane with openings in a honeycomb pattern. Additional small perforations can be made in between each opening in the honeycomb structure to further enhance the mesh transparency, and thus the overall metasurface transparency. The metallic hexagonal resonating elements can be single ring resonators, or multiple ring resonators to increase the phase range. In one implementation, the overall reflectarray structure achieves 85.1 percent transparency and thus may be integrated with infrastructure without being significantly visible.

### RELATED APPLICATION

The subject patent application claims priority to U.S. Provisional Patent Application Ser. No. 63/747,219, filed Jan. 20, 2025, and entitled “OPTICALLY TRANSPARENT REFLECTIVE METASURFACE WITH INCREASED OPACITY UTILIZING MESHED UNIT-CELLS” (docket no. 141984.01/DELLP1500US), the entirety of which priority patent application is hereby incorporated by reference herein.

### BACKGROUND

High-frequency wireless signals, such as millimeter wave signals including Ka, V, W bands and higher frequency bands, experience severe path loss or blockage with respect to many types of obstructions. Such obstructions often include materials used in many common structures found in urban or indoor environments.

One way to avoid obstructions in wireless communications is through the use of metasurfaces, sometimes referred to as reconfigurable intelligent surfaces, which can be positioned to reflect radio frequency signals around obstacles. In general, metasurfaces are two-dimensional (2D) synthetic structures, having electromagnetic (EM) scattering properties that can be finely tuned to achieve anomalous reflection and transmission of wireless signals. More particularly, a metasurface is an array of resonant structures (unit cells) that are subwavelength in periodicity, such that by modulating the scattered magnitude and phase on a per-unit cell basis, a near-continuous complex reflectivity and transmittivity profile can be achieved. Through establishing a phase profile, for example, the main lobe of the scattered field can be steered towards a desired target in reflection or transmission.

### BRIEF DESCRIPTION OF THE DRAWINGS

The technology described herein is illustrated by way of example and not limited in the accompanying figures in which like reference numerals indicate similar elements and in which:

FIG. 1A is a top-view representation of an example hexagonal unit cell configured with a honeycomb mesh ground plane portion of a honeycomb mesh structure with openings to increase optical transparency, in accordance with various example embodiments and implementations of the subject disclosure.

FIG. 1B is a top-view representation of an example hexagonal unit cell configured with a honeycomb mesh ground plane portion of a honeycomb mesh structure with openings, and additional small perforations between the openings to further increase optical transparency (relative to FIG. 1A), in accordance with various example embodiments and implementations of the subject disclosure.

FIG. 2A is a graphical representation showing magnitude of reflected electromagnetic waves from an example hexagonal unit cell designed with a honeycomb mesh ground plane portion, in accordance with various example embodiments and implementations of the subject disclosure.

FIG. 2B is a graphical representation showing phase response of reflected electromagnetic waves from an example hexagonal unit cell designed with a honeycomb mesh ground plane portion, in accordance with various example embodiments and implementations of the subject disclosure.

FIG. 3A is a representation of an example unit cell with a hexagonal ring resonator and a honeycomb ground plane, in accordance with various example embodiments and implementations of the subject disclosure.

FIG. 3B is a graphical representation showing the phase range of the example unit cell of FIG. 3A, in accordance with various example embodiments and implementations of the subject disclosure.

FIG. 4 is a representation showing an example metasurface reflector (reflectarray) of unit cells with hexagonal ring resonators and a honeycomb ground plane, along with a zoomed-in portion thereof, in accordance with various example embodiments and implementations of the subject disclosure.

FIGS. 5A and 5B are graphical representations of simulated radiation patterns of the example reflectarray of FIG. 4, in accordance with various example embodiments and implementations of the subject disclosure.

FIG. 6 is an image of an example fabricated reflectarray (left) and an enlarged portion thereof (right) captured through a microscope, in accordance with various example embodiments and implementations of the subject disclosure.

FIGS. 7A, 7B, 8A and 8B show radiation patterns of the example simulated metasurface, and example fabricated metasurface, in accordance with various example embodiments and implementations of the subject disclosure.

FIGS. 9A and 9B are top views of example unit cells above a honeycomb mesh ground plane portion showing dimensions of a single hexagonal ring resonating element, and a resonating element with two hexagonal rings, respectively, in accordance with various example embodiments and implementations of the subject disclosure.

FIG. 10 is a representation showing a portion of an example honeycomb meshed ground plane and design dimensions thereof, in accordance with various example embodiments and implementations of the subject disclosure.

FIG. 11 is a representation of an example simulation setup including an example modeled reflectarray antenna, in accordance with various example embodiments and implementations of the subject disclosure.

FIG. 12 is a graphical representation showing example magnitude responses for a single ring resonating element (left) and dual-ring resonating element (right), in accordance with various example embodiments and implementations of the subject disclosure.

FIG. 12 is a graphical representation showing example phase responses for a single ring resonating element (left) and dual-ring resonating element (right), in accordance with various example embodiments and implementations of the subject disclosure.

### DETAILED DESCRIPTION

The technology described herein is generally directed towards a metasurface, sometimes referred to as a reflectarray, with high optical transparency. The metasurface includes a fused-silica dielectric substrate, which is completely (or virtually completely) optically transparent, and a perforated metal ground plane. In one implementation, the ground plane is a mesh with openings, referred to as a honeycomb lattice or mesh, to increase optical transparency compared to a flat sheet of metal (which is most commonly used for a ground plane). In another implementation the ground plane includes smaller perforations arranged between the openings in the hexagonal lattice. Experimental results of a fabricated reflector demonstrate exceptional performance.

In general, reflect arrays include a dielectric substrate that is sandwiched with reflecting elements on one side, and a metal ground plane on the other. A feed antenna is used to illuminate the reflectarray surface and the reflecting elements steer the incident radiation into a particular direction. From array theory, the geometries of the reflecting elements can be strategically selected to achieve a certain phase distribution across the reflectarray surface which will then cause incident radiation to be reflected in a particular direction.

Radio frequency (RF) signals in the millimeter wave (mm-wave) band (28-110 GHz) and beyond will deliver the high data-rates and throughput of next-generation wireless communication networks. To reiterate, a major disadvantage of these wireless links is their deterioration resulting from physical obstacles that absorb and scatter high-frequency radio waves. In order to leverage the high throughput of high-frequency communication links for next-generation wireless networks, the metasurface technology described herein can be used to intelligently steer the electromagnetic waves around such obstacles.

More particularly, described herein is an optically transparent reflection-type metasurface that can control the reflection of mm-wave signals through engineered windows or the like into otherwise shadowed (e.g., interior) locations. As will be understood, a honeycomb-mesh ground plane is implemented to increase optical transparency. In one implementation, an optical transparency of around ninety-one percent (91%) is reached for the honeycomb mesh with perforations, and 83.5% for the reflectarray as a whole. At the same time, a phase range of 330 degrees (330°) is achieved with the honeycomb ground plane, which is a similar phase range to that achieved with a solid metal ground plane. Note that the substrate used (fused silica) is (virtually) optically transparent, thereby not significantly reducing the transparency of the rest of the metasurface.

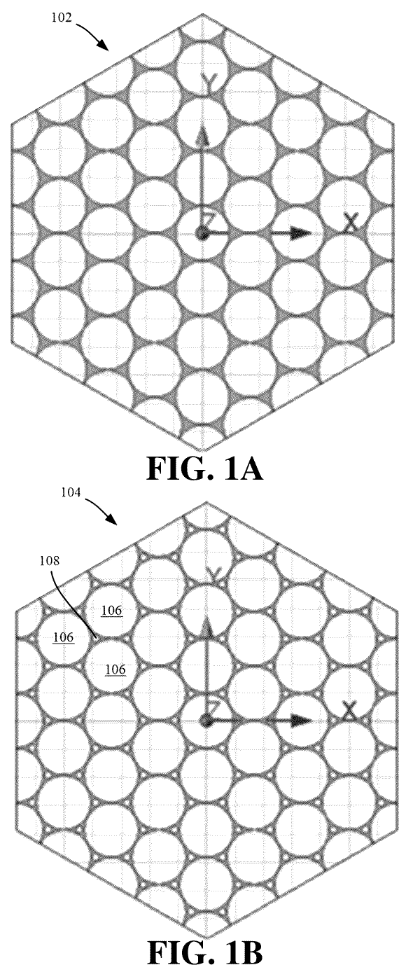

FIGS. 1A and 1B show examples of two different types of honeycomb mesh ground planes 102 and 104, respectively, for hexagonal unit cells. The mesh ground plane 102 of FIG. 1A is a honeycomb structure, which in this example has hole radii of 0.19 mm. In the honeycomb mesh ground plane 104 of FIG. 1B, in between the holes (three of the holes are labeled holes 106) are additional smaller diameter perforations included in the design to further increase optical transparency (relative to FIG. 1A); one perforation, between the three labeled holes 106, is labeled 108.

The optical transparency (OT) of a meshed surface is:

$$OT = \frac{Area of Perforations}{Area of a flat PEC} .$$

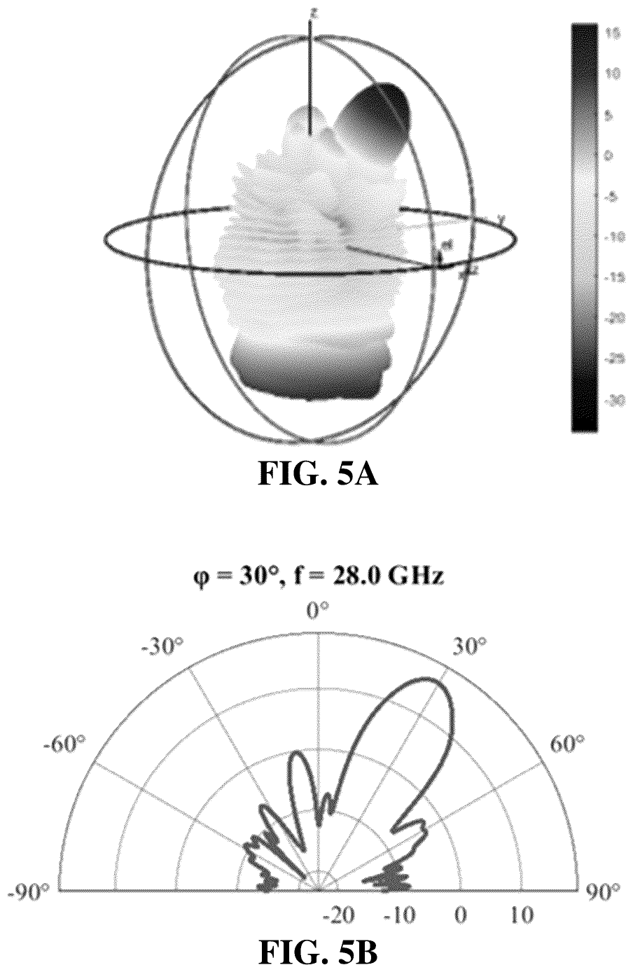

The area of the openings of the meshes are 5.4437 mm² in FIG. 1A and 5.6412 mm² in FIG. 1B. The optical transparency of the unit cells are then:

$${OT}_{F IG . 1 A} = \frac{5.4437}{6.2085} = 87.68 \%$$

$${OT}_{F IG . 1 B} = \frac{5.6412}{6.2085} = 90.86 \% .$$

Note that these calculations presented above are purely for the ground plane and do not include the total transparency when a metallic resonating element is overlayed on top.

Simulations with Floquet-port excitations were performed to compare the reflection to that of a flat PEC sheet. Note that with a flat perfect electric conductor (PEC) sheet used in modeling, all of the radiation is reflected back, meaning the magnitude of the reflection would be equal to 1 on a linear scale, or 0 dB on a logarithmic scale. The phase of the reflected waves relative to the incident is 180°.

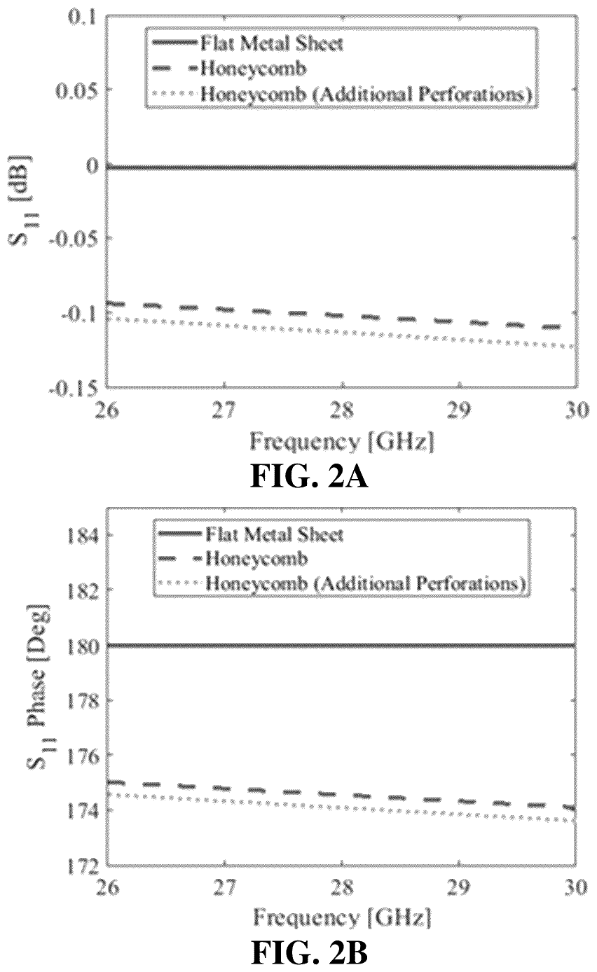

The magnitude and phase of the reflected waves are shown in FIGS. 2A and 2B for the frequency range 26-30 GHz, which is the range within which the designed metasurface reflector operates. More particularly, the plot of FIG. 2A shows the magnitude of the reflection, while the plot of FIG. 2B shows its phase response. It is seen that the magnitude and phase are approximately −0.1 dB and 1750 degrees in this frequency range, which is very close to the performance of a flat PEC.

Described herein is how the honeycomb ground plane performs in a metasurface reflector. A reflector with a one-dimensional (1-D) phase profile is described in general although simulating a surface with fine perforations in the ground plane and a two-dimensional (2-D) phase profile illuminated by a feed antenna is achieved.

For a metasurface reflector, a phase profile is established across the surface in order to steer a beam in a particular direction. For a 1-D phase profile, the difference in phase between adjacent elements along the x-axis for example is:

$$Δ ϕ = {n}_{i} {k}_{0} p sin {θ}_{r}$$

according to the generalized Snell's law, where nᵢ is the index of refraction of the medium of the incident wave, k₀ is the free-space wavenumber, p is the period of a unit cell, and θᵣ is the direction of reflection with respect to the z-axis.

Achieving a phase range of 360 degrees across all the scattering elements used in the reflector degrees is ideal; practically, depending on various factors such as the substrate used and unit cell size, 360 degrees is typically not achievable. However, a phase range of approximately 330 degrees is very realistic, which is highly sufficient in most scenarios.

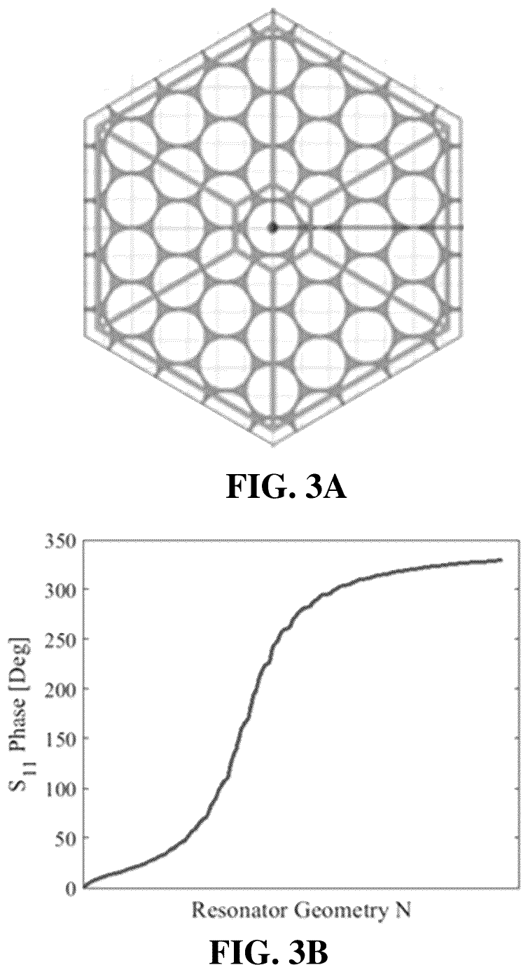

A unit cell with a hexagonal ring resonator is shown in FIG. 3A, comprised of 25 micron-wide metal lines above a honeycomb ground plane portion. The ring outer dimensions can vary from 0.3 to 3 mm and the inner dimension can vary from 0.1 to 1 mm. As is understood, these dimensions, as well as any other dimensions described herein, are nonlimiting example design dimensions that can be varied as appropriate for particular applications.

The unit cell was simulated in Ansys HFSS with Floquet-port excitations to measure the phase response. The phase range of the unit cell with the hexagonal ring resonator and the honeycomb ground plane of FIG. 3A is shown in FIG. 3B, in which the phase range is shown to be 330°. Therefore, a sufficiently large phase range is achievable with the honeycomb mesh ground plane.

The phase range is shown in FIG. 3A, of a unit cell with a hexagonal ring resonator and a honeycomb ground plane (FIG. 3B). More particularly, in one implementation, the phase response (FIG. 3A) of a unit cell with a hexagonal ring resonator shown in FIG. 3B is comprised of 25 micron-wide metal lines on the honeycomb ground plane shown. The ring outer dimensions vary from 0.3 to 3 mm and the inner dimension vary from 0.1 to 1 mm. The unit cell was simulated in Ansys HFSS with Floquet-port excitations to measure the phase response, in which the phase range is shown to be 330°. Therefore, a sufficiently large phase range is achievable with the honeycomb mesh ground plane.

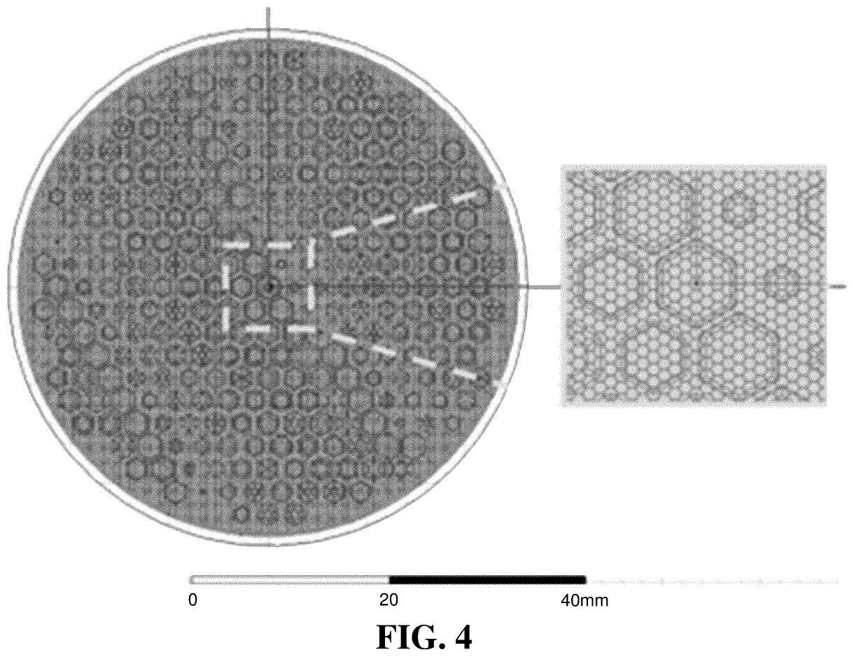

FIG. 4 shows a metasurface reflector with a 1-D phase gradient with θᵣ=30° and a honeycomb mesh ground plane corresponding to the unit cell 102 of FIG. 1A; a zoomed-in view of a portion of the unit cell is also shown on the right side of FIG. 4. The 1-D metasurface reflector with the standard honeycomb ground plane is generated and designed to reflect a beam at (θ, φ)=(30°, 30°).

A simulation with a plane-wave excitation was performed in HFSS with the reflectarray shown in FIG. 4. The simulated radiation pattern is shown of FIGS. 5A and 5B, and as can be seen, the reflector steers the beam at the desired direction with side-lobe levels of approximately 16 dB.

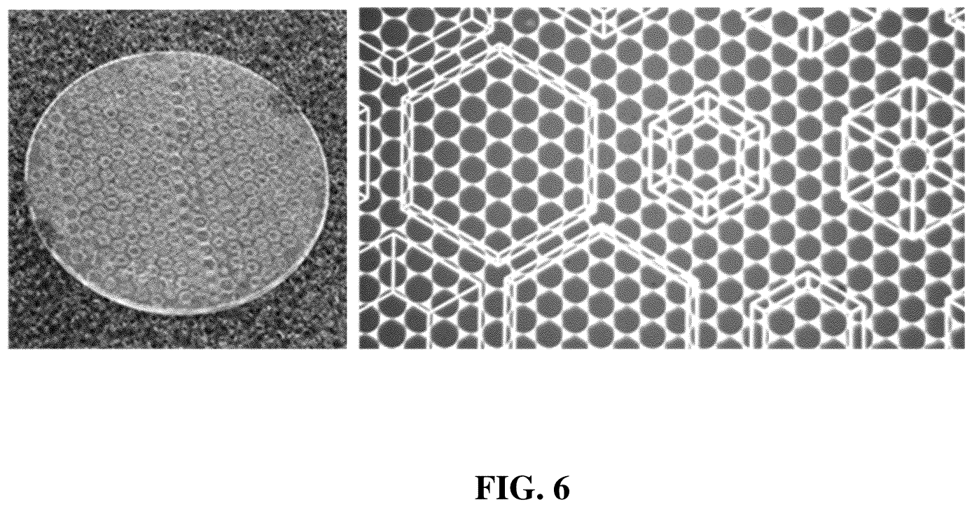

An example actual reflectarray structure was fabricated, and is shown in FIG. 6. The deposited metallization layers are approximately 0.7 microns thick; (the right image is an enlarged portion of the fabricated reflectarray when placed under a microscope).

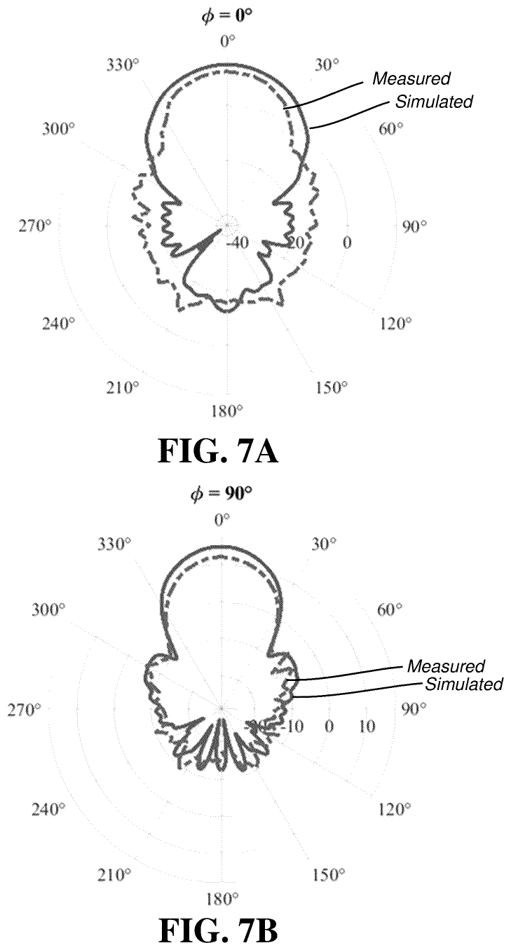

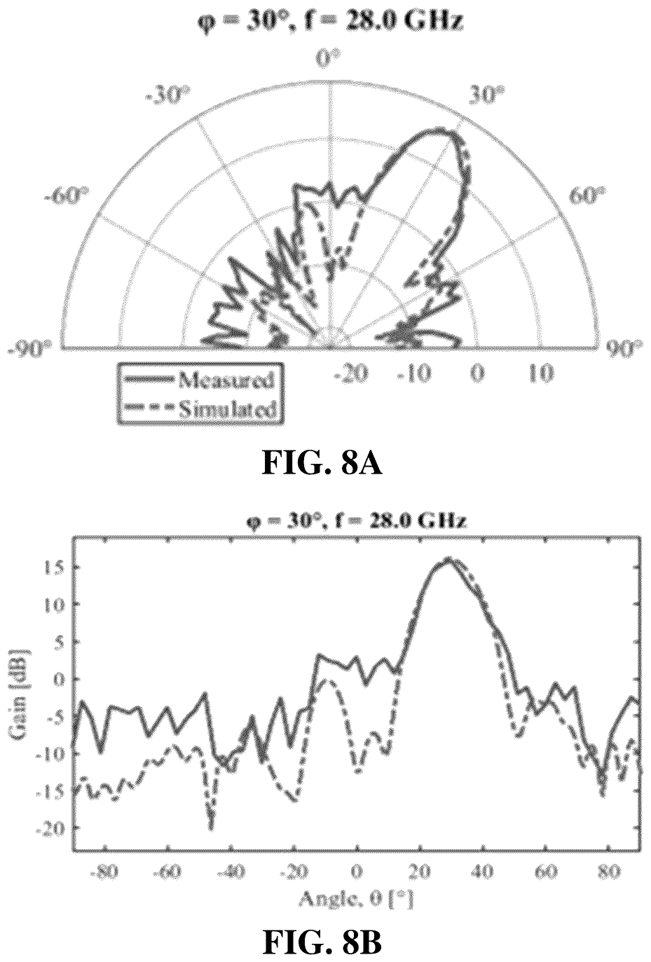

The radiation patterns based on the horn antenna are shown in FIGS. 7A, 7B, 8A and 8B including gain in dB at 28 GHz, for azimuthal angles of φ equal to 0° and 90°, in FIGS. 7A and 7B, respectively and φ equal to 30° in FIG. 8A. The solid lines show the simulated patterns, while the dashed lines show the measured patterns of the fabricated array. As is readily apparent, the measured results closely match the simulated performance.

As can be seen, with a reflector unit cell using the honeycomb ground plane, a similar phase range to that of a flat ground plane is achieved. The fabricated array, with a theoretical transparency of 83.5%, achieves a similar performance relative to the simulated structure.

Described herein is an optically-transparent reflectarray based on a metal mesh and fine metal line structures to achieve a high optical transparency of 85.1%. The unit cells are comprised of a fused silica substrate, a honeycomb-meshed ground plane, and fine metal line ring elements. Such unit cells show a low return loss of 0.77 dB.

Different ring resonator configurations can be used to extend the phase variation, and a total phase range of 330° is achieved. The designed reflectarray beam-steers in the direction (θ=30°, φ=0°) at 28 GHz and achieves a peak gain.

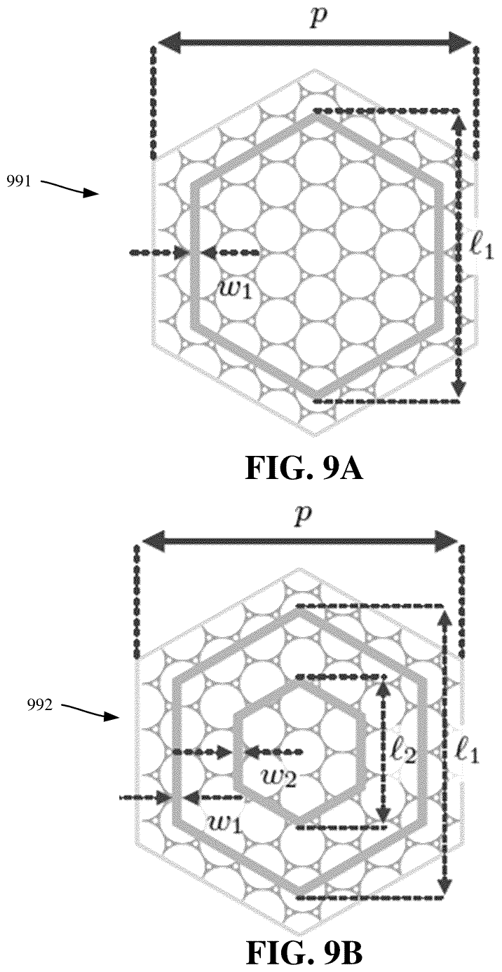

One such unit cell has a hexagonal geometry to maximize the number of unit cells that can populate a wafer, including a circular wafer. A top view of the example unit cell 991 with a single hexagonal ring is illustrated in FIG. 9A; dimensions shown are p=2.68 mm, w₁=50 μm, l₁∈[0.5, 2.9] (mm).

FIG. 9B shows a top view of an example unit cell 992 with two hexagonal rings, in which p=2.68 mm, w₁=50 μm, l₁=2.9 mm, w₂=50 μm. The periodicity p, with respect to the horizontal direction is 2.68 mm, corresponding to λ0/4 at 28 GHz.

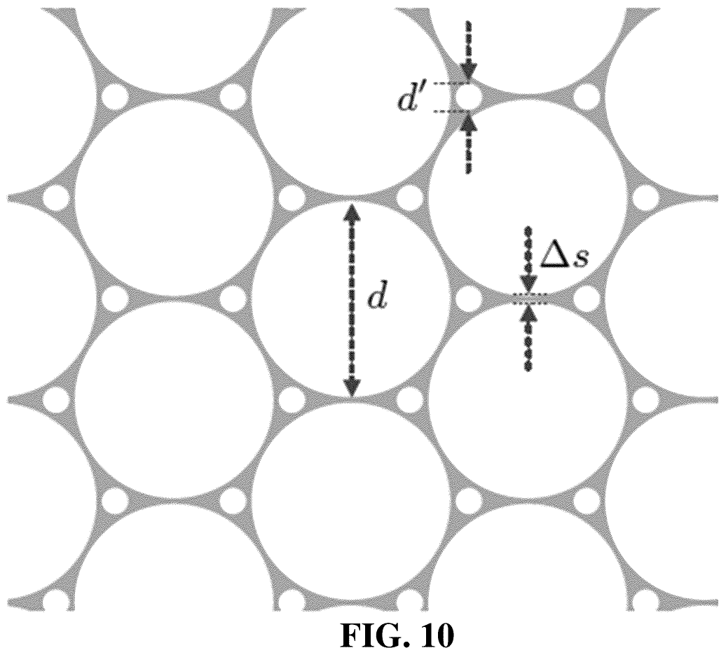

FIG. 10 shows a portion of the honeycomb meshed ground plane with perforations between the mesh openings (puncture holes). In this example, the diameters of the holes are d=0.19 mm, separated by distances Δs≈6.5 μm, with in-between perforation diameters of d′=25 μm.

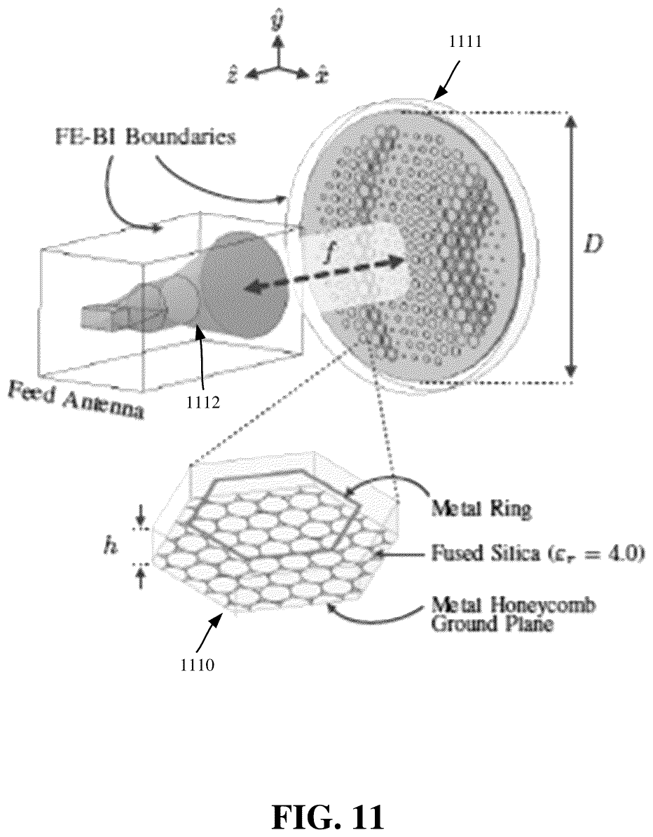

As shown in the enlarged 3D unit cell representation 1110 in FIG. 11, in this example a fused silica substrate (εᵣ=4.0) with a thickness h=1 mm is used due to its high optical transparency and low loss. The top layer is a fine metal line structure of a hexagonal metal ring (or rings, FIG. 9B) comprised of 50 μm linewidths. Two fine metal line configurations can be implemented to increase the phase range of the unit cells; in these scenarios, the ring widths (w₁, w₂) are fixed at 50 μm as in FIG. 9B. The length of the ring l₁ in the first configuration of FIG. 9A is varied up until the point where its phase response begins to saturate. Then, the second configuration of FIG. 9B has the length of the outer ring l₁ is kept at its maximum value and the inner ring's length l₂ may be adjusted.

The bottom layer includes a ground plane meshed in a honeycomb pattern, such as the based on the honeycomb meshed ground plane (portion) shown in FIG. 10. In this example, the dimensions are d=0.19 mm, d′=25 μm, Δs≈6.5 μm. The honeycomb mesh has punctures with a diameter d=0.19 mm and an adjacent spacing Δs=6.5 μm. There are additional, smaller punctures (referred to herein as perforations) between the larger holes to further increase the transparency; the perforations in this example have diameters d′=25 μm.

Taken together as shown in the setup of FIG. 11, the full reflectarray 1111 of unit cells is synthesized and simulated/modeled in Ansys HFSS h=1 mm, f=D=50.8 mm. The diameter of the wafer D is 50.8 mm. To achieve good illumination efficiency, the offset f of the feed antenna 1112 was set to 50.8 mm such that f/D=1. The feed antenna 1112 was designed such that the edge taper is −8 dB.

The reflectarray 1111 is designed to beam-steer in the direction (θ=30°, φ=0°) at an operating frequency of 28 GHz. To achieve this, a particular phase distribution is established across the reflectarray's surface and the phase center of the feed antenna is known. The reflection phase of the i^{th} element positioned at (xᵢ, yᵢ) in the reflectarray used to beam-steer in the direction(θ_{b}, φ_{b}) can be computed with the following equation:

$${ϕ}_{i} ( {x}_{i} , {y}_{i} ) = {k}_{0} [ {R}_{i} - ( {x}_{i} cos {ϕ}_{b} + {y}_{i} sin {ϕ}_{b} ) sin {θ}_{b} ]$$

where k₀ is the free-space wave number and Riis the distance of the i^{th} element from the phase center of the feed antenna.

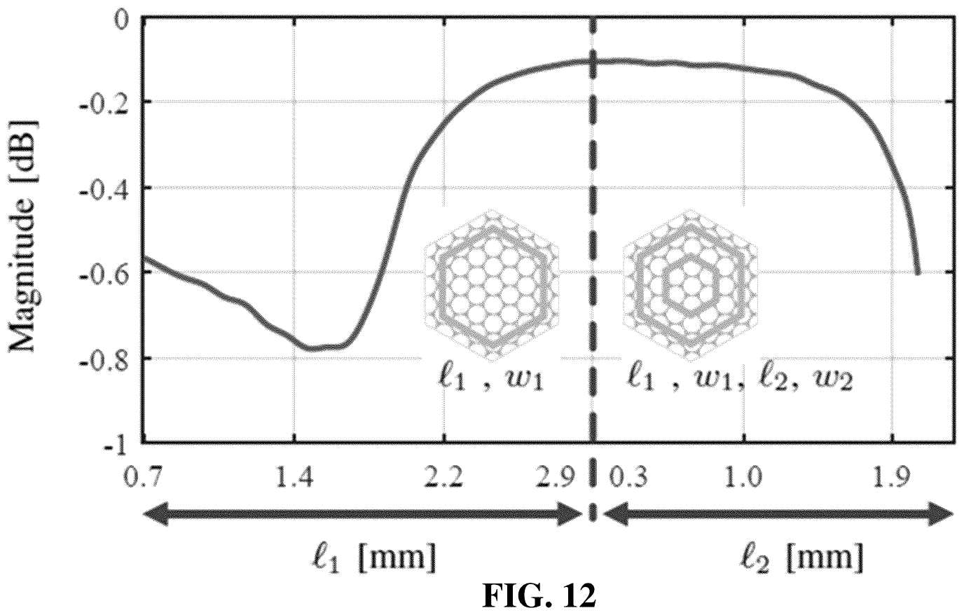

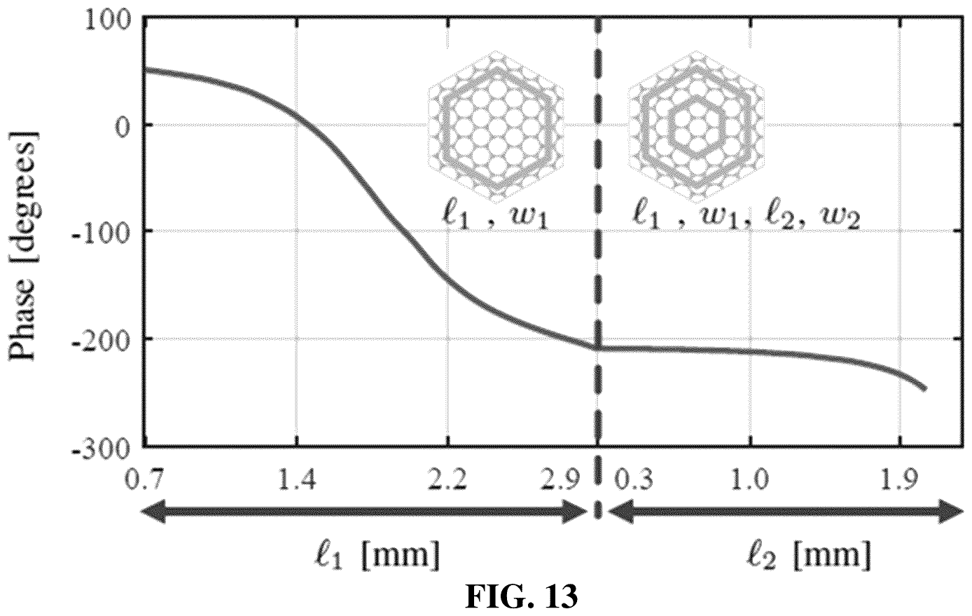

The reflection responses for the unit cells of FIGS. 9A and 9B at 28 GHz are shown in FIG. 12. The responses for the two different unit cell configurations are separated by the black dashed line in the center of FIG. 12; left of the line is the case when there is a single hexagonal ring element in the unit cell, and to the right of the line is when there are two hexagonal rings per unit cell. The return loss across the different ring lengths in FIG. 11 reaches a peak of 0.77 dB, which is relatively low. In FIG. 13, (depicted similarly to FIG. 12 but for phase rather than magnitude) it can be seen that the first configuration achieves a phase variation from +50° to −200, and that by then introducing the second hexagonal ring, the phase range can be extended to −248°. Therefore, a total phase range of 298° is achieved.

One or more implementations can be embodied in a device, such as described in the example embodiments and implementations included herein. The device can include a metallic ring resonator, and a mesh ground plane beneath the metallic ring resonator, the mesh ground plane including a metal mesh structure having optically transparent openings. The metallic ring resonator and a portion of the mesh ground plane beneath the metallic ring resonator can form a substantially optically transparent unit cell.

The device further can include an optically transparent, or substantially optically transparent, substrate between the metallic ring resonator and the mesh ground plane.

The substantially optically transparent unit cell can be part of a honeycomb lattice of unit cells.

The substantially optically transparent unit cell can be part of a metasurface of unit cells.

The metallic ring resonator can be a first metallic ring resonator of a first unit cell of the metasurface, the first metallic ring resonator can have a first size, and the metasurface can include a second unit cell that can include a second metallic ring resonator of a second size that can be different from the first size.

The optically transparent openings can be circular or substantially circular.

The device further can include perforations between at least some of the openings in the mesh ground plane.

The metallic ring resonator can include a single ring resonator.

The metallic ring resonator can include a first, outer ring resonator ring, and a second, inner ring resonator ring.

One or more implementations can be embodied in a metasurface, such as described in the example embodiments and implementations included herein. The metasurface can include an optically transparent, or substantially optically transparent, substrate, and a group of respective unit cells above the optically transparent, or substantially optically transparent, substrate; the respective unit cells can include respective metallic resonators. The metasurface can include a mesh ground plane beneath the optically transparent, or substantially optically transparent, substrate, in which the mesh ground plane can include openings that can be optically transparent or substantially optically transparent.

The respective metallic resonators can include respective single ring resonators, or the respective metallic resonators can include respective outer ring resonators and respective inner ring resonators.

The respective metallic resonators can be above respective portions of the mesh ground plane, and the respective portions can include respective groups of at least one of: respective full openings or respective partial openings.

The respective metallic resonators can include a first metallic ring resonator of a first unit cell of the group of the respective unit cells, and a second metallic ring resonator of a second unit cell of the group of the respective unit cells, and the first metallic ring resonator can have a first size that can be different from a second size of the second metallic ring resonator.

The respective unit cells can be hexagonal based on the respective metallic resonators being hexagonal.

The openings can be circular or substantially circular, and the openings can include equal or substantially equal diameters.

The metasurface further can include perforations between at least some of the openings in the mesh ground plane.

One or more implementations can be embodied in a unit cell, such as described in the example embodiments and implementations included herein. The unit cell can include a metallic resonating element, a substrate beneath the metallic resonating element, and a metal mesh structure corresponding to a ground plane beneath the substrate. The metal mesh structure can include optically transparent openings, and can include perforations between the optically transparent openings. In response to an electromagnetic wave impinging on the unit cell at a frequency that resonates the metallic resonating element, the unit cell can redirect an instance of the electromagnetic wave.

The metallic resonating element can include a hexagonally-shaped single ring resonator, or the metallic resonating element can include a hexagonally-shaped outer ring resonator and a hexagonally-shaped inner ring resonator.

The openings can be circular or substantially circular, and the perforations can be circular or substantially circular.

The unit cell can be a first unit cell of a metasurface of unit cells that can include the first unit cell and a second unit cell, and the first unit cell can have a larger size relative to the second unit cell.

As can be seen, described herein is a high transparency reflectarray using a honeycomb metal meshing scheme with fine metal line structures. The reflectarray includes a fused silica substrate backed by a honeycomb-meshed ground plane. The scattering elements can be fine metal line hexagonal rings, e.g., with linewidths of 50 μm. At the design frequency of 28 GHz, the peak return loss of the unit cell is 0.77 dB and a large phase range of 298° is achieved. The simulated reflectarray has a peak gain. In one implementation, an optical transparency of 85.1% is achieved, making the described reflectarray a suitable candidate for integration with transparent surfaces found in urban spaces. This reflectarray may be deployed on transparent surfaces, such as windows, to produce an aesthetic environment with enhanced signal coverage for 5G communication systems.

Also described is an even higher transparency reflectarray using the honeycomb metal meshing scheme with fine metal line structures, in which perforations are present between the mesh openings. An optical transparency of 90.86% (not including the metal resonator ring or rings) is achieved with the additional perforations.

By way of some nonlimiting usage examples, consider smart windows for urban buildings, such as a modern office building with large glass windows; an optically transparent reflective metasurface can be integrated into the glass panels. This allows the metasurface to redirect incoming mm-wave signals around obstacles like furniture or structural columns, ensuring reliable high-speed wireless connectivity throughout the office. Simultaneously, the transparent nature of the metasurface preserves the aesthetic appeal of the glass windows and allows natural light to enter the space, maintaining a bright and open environment.

In a retail setting, transparent displays used for digital signage can incorporate an optically transparent reflective metasurface. The display can also function as a beamforming device, directing mm-wave signals to specific areas within the store to enhance wireless connectivity for customers. The metasurface described herein remains substantially invisible to the naked eye, allowing the digital content on the display to be viewed without any significant interference, while simultaneously improving the store's wireless network performance.

In densely populated urban environments, installing optically transparent reflective metasurfaces on the surfaces of bus shelters, light poles, street lamps and so on can significantly improve wireless signal coverage. Such metasurfaces can direct signals to areas with poor reception, such as narrow streets or heavily congested zones, without obstructing visibility or altering the appearance of the infrastructure. This approach can enhance network reliability and coverage in challenging urban environments.

In modern vehicles equipped with transparent panoramic roofs, an optically transparent reflective metasurface can be within or near the glass to help in redirecting mm-wave signals within the vehicle, ensuring that occupants experience consistent and reliable in-car connectivity, even in areas with weak external signals. The transparency of the metasurface ensures that passengers can still enjoy unobstructed views through the panoramic roof, maintaining the vehicle's design aesthetics.

Thus, described herein is an optically transparent reflectarray (RA) for millimeter-wave (mm-wave) applications based on a honeycomb metal-meshing scheme and fine metal line (FML) structures. The reflectarray elements are arranged in a hexagonal lattice structure to achieve a high packing density of reflectarray elements. Example implementations of the reflectarray unit cell include fine metal line hexagonal rings with linewidths of 50 μm deposited on 1 mm-thick fused silica (εᵣ=4.0), which is backed with a metal ground plane with perforations in a honeycomb pattern. Additional small punctures (perforations) can be made in between each opening in the honeycomb to further enhance the transparency; such a honeycomb ground plane with perforations achieves an optical transparency of 91%.

Example implementations of the unit cell can include two configurations with respect to the hexagonal rings to increase the phase range. The design frequency of the reflectarray is 28 GHz; across the various unit cell ring configurations, a peak return loss of 0.77 dB is and a phase range of 298° is achieved. The reflectarray structure is simulated with Ansys HFSS and a peak gain is achieved with a maximum side-lobe level (SLL). The overall reflectarray structure achieves 85.1% transparency and may be integrated with infrastructure such as glass panels to improve signal coverage.

Currently, most mobile networks utilize sub-3 GHz bands which is inadequate to meet the growing number of connected devices and mobile use traffic. Next generation wireless networks will extend their bandwidth to the millimeter wave (mm-wave) band (30-300 GHz) due to the large spectral availability. However, electromagnetic (EM) waves at these high frequencies experience large free-space propagation loss and are susceptible to significant attenuation from physical obstructions in its path. Urban infrastructure such as buildings, walls, trees, and glass panels cause blockage and can lead to regions of poor coverage. As a result, mm-wave wireless networks are heavily dependent on line-of-sight (LOS) communication links to in order to reduce these dead zones.

Reflectarrays (RAs) have garnered a lot of attention as a solution to address the challenge of maintaining LOS conditions for wireless mm-wave systems. Reflectarrays are planar arrays whose scattering elements can be engineered to control the reflected wavefront of the EM waves. Because reflectarrays are capable of high gain, are low profile, and simple to fabricate, they are a promising beam-steering technology. It is envisioned that future communication systems will use reflectarrays, or smart reflective surfaces, to guide signals directly to the users to enhance the signal coverage in challenging indoor and outdoor environments.

As described herein, optically-transparent reflectarrays have advantages that transparency offers in various applications. To meet the aesthetic requirements of urban environments, transparent reflectarrays may be overlaid with transparent surfaces, such as windows and glass walls in shopping centers. As a result, signal coverage in the environment will be enhanced without obstructing the urban infrastructure already in place.

What has been described above include mere examples. It is, of course, not possible to describe every conceivable combination of components, materials or the like for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A device, comprising:
a metallic ring resonator; and
a mesh ground plane beneath the metallic ring resonator, the mesh ground plane comprising a metal mesh structure having optically transparent openings,
wherein the metallic ring resonator and a portion of the mesh ground plane beneath the metallic ring resonator form a substantially optically transparent unit cell.

2. The device of claim 1, further comprising an optically transparent, or substantially optically transparent, substrate between the metallic ring resonator and the mesh ground plane.

3. The device of claim 1, wherein the substantially optically transparent unit cell is part of a honeycomb lattice of unit cells.

4. The device of claim 1, wherein the substantially optically transparent unit cell is part of a metasurface of unit cells.

5. The device of claim 4, wherein the metallic ring resonator is a first metallic ring resonator of a first unit cell of the metasurface, wherein the first metallic ring resonator has a first size, and wherein the metasurface comprises a second unit cell comprising a second metallic ring resonator of a second size that is different from the first size.

6. The device of claim 1, wherein the optically transparent openings are circular or substantially circular.

7. The device of claim 1, further comprising perforations between at least some of the openings in the mesh ground plane.

8. The device of claim 1, wherein the metallic ring resonator comprises a single ring resonator.

9. The device of claim 1, wherein the metallic ring resonator comprises a first, outer ring resonator ring, and a second, inner ring resonator ring.

10. A metasurface, comprising:
an optically transparent, or substantially optically transparent, substrate;
a group of respective unit cells above the optically transparent, or substantially optically transparent, substrate, the respective unit cells comprising respective metallic resonators; and
a mesh ground plane beneath the optically transparent, or substantially optically transparent, substrate, the mesh ground plane comprising openings that are optically transparent or substantially optically transparent.

11. The metasurface of claim 10, wherein the respective metallic resonators comprise respective single ring resonators, or wherein the respective metallic resonators comprise respective outer ring resonators and respective inner ring resonators.

12. The metasurface of claim 10, wherein the respective metallic resonators are above respective portions of the mesh ground plane, the respective portions comprising respective groups of at least one of: respective full openings or respective partial openings.

13. The metasurface of claim 10, wherein the respective metallic resonators comprise a first metallic ring resonator of a first unit cell of the group of the respective unit cells, and a second metallic ring resonator of a second unit cell of the group of the respective unit cells, and wherein the first metallic ring resonator has a first size that is different from a second size of the second metallic ring resonator.

14. The metasurface of claim 10, wherein the respective unit cells are hexagonal based on the respective metallic resonators being hexagonal.

15. The metasurface of claim 10, wherein the openings are circular or substantially circular, and wherein the openings comprise equal or substantially equal diameters.

16. The metasurface of claim 10, further comprising perforations between at least some of the openings in the mesh ground plane.

17. A unit cell, comprising:
a metallic resonating element;
a substrate beneath the metallic resonating element; and
a metal mesh structure corresponding to a ground plane beneath the substrate, the metal mesh structure comprising optically transparent openings, and comprising perforations between the optically transparent openings,
wherein, in response to an electromagnetic wave impinging on the unit cell at a frequency that resonates the metallic resonating element, the unit cell redirects an instance of the electromagnetic wave.

18. The unit cell of claim 17, wherein the metallic resonating element comprises a hexagonally-shaped single ring resonator, or wherein the metallic resonating element comprises a hexagonally-shaped outer ring resonator and a hexagonally-shaped inner ring resonator.

19. The unit cell of claim 17, wherein the openings are circular or substantially circular, and wherein the perforations are circular or substantially circular.

20. The unit cell of claim 17, wherein the unit cell is a first unit cell of a metasurface of unit cells that comprises the first unit cell and a second unit cell, and wherein the first unit cell has a larger size relative to the second unit cell.
